(19) United States
(12) Patent Application Publication
(10) Pub. No.: US 2006/0046831 A1
(43) Pub. Date: Mar. 2, 2006

(54) Gaming machine

(75) Inventors: Shinya Takano, Tokyo (JP); Kazunobu Sato, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/209,027

(22) Filed: Aug. 23, 2005

(30) Foreign Application Priority Data
Aug. 25, 2004 (JP) 2004-245258

(51) Int. Cl. A63F 13/00

(52) U.S. Cl. 463/20

(57) ABSTRACT

In the slot machine 1 of the embodiment, in a case that it is conducted the substitution display that the symbol “LOBSTER” is stopped and displayed instead of the symbol “WILD” which is finally stopped and displayed in any of the stop display areas 211, 212, 213 of the variable display portion 21 (S121: YES), and any of the stop display areas 211, 212, 213, in which the symbol “LOBSTER” is stopped and displayed, of the variable display portion 21 is touched by the finger 128 of the player, thereby the execution of the substitution display is instructed (S123: YES), the symbol “LOBSTER” is substituted for the symbol “WILD” and the symbol “WILD” is displayed (S124). And coins are paid out corresponding to the symbol combination displayed on each of the variable display portions 21 to 24 after the substitution display is conducted.

### CROSS-REFERENCE TO THE RELATED APPLICATIONS (S)

This application is based upon and claims a priority from the prior Japanese Patent Application No. 2004-245258 filed on Aug. 25, 2004, the entire contents of which are incorporated herein by reference.

### BACKGROUND OF THE INVENTION

1. Field of the Invention

The present invention relates to a gaming machine in which a game is conducted by utilizing symbols variably displayed and stopped.

2. Description of Related Art

In a conventional gaming machine, for example, a slot machine, it is constructed so that a plurality of reels are rotated for a predetermined time and coins are paid out corresponding to a symbol combination in a state that the reels are stopped, as disclosed in Unexamined Japanese Patent Publication No. 2003-180908.

Here, rotation of each of the reels is started by operation of a bet button or a start lever and stop of each of the reels is automatically done, therefore a player has to only see rotation and stop of the reels and if a symbol combination according to which coins are paid out is realized, such symbol combination only happens to be realized. Thus, the player cannot have a feeling that the player actively conducts a game by himself to an extent that a result of a slot game is influenced.

### SUMMARY OF THE INVENTION

Therefore, the present invention has been done and has an object to provide a gaming machine in which a feeling that a player actively conducts a game can be given to the player in a game that coins are paid out corresponding to a symbol combination which is automatically stopped and displayed.

In order to accomplish the above object, according to one aspect of the present invention, it is provided a gaming machine comprising:
a display device for displaying plural kinds of symbols including a first symbol and a second symbol;
a first determination device for determining a winning symbol combination;
a second determination device for determining whether or not the winning symbol combination determined by the first determination device includes the first symbol;
a contact input device arranged on a display plane of the display device, the contact input device operating in cooperation with the display plane of the display device; and
a display control device for controlling the display device;
wherein the display control device controls the display device to display a symbol combination constructed from the winning symbol combination in which the second symbol is included instead of the first symbol if the second determination device determines that the winning symbol combination includes the first symbol, and
wherein the display control device controls the display device to substitute the second symbol in the symbol combination for the first symbol and display the winning symbol combination including the first symbol when the second symbol is touched through the contact input device.

In the gaming machine of the present invention, the display control device controls the display device to display a symbol combination constructed from the winning symbol combination in which the second symbol is included instead of the first symbol if the second determination device determines that the winning symbol combination includes the first symbol, and the display control device controls the display device to substitute the second symbol in the symbol combination for the first symbol and display the winning symbol combination including the first symbol when the second symbol is touched through the contact input device. Therefore, a feeling that a player actively conducts a game can be given to the player in a game that coins are paid out corresponding to a symbol combination which is automatically stopped and displayed.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is an explanatory view showing a substitution display example by utilizing five variable display portions in the embodiment,

FIG. 2 is an explanatory view showing a symbol combination example stopped and displayed through five variable display portions in the embodiment,

FIG. 3 is an explanatory view showing one winning symbol combination realized on the basis of the symbol combination shown in FIG. 2,

FIG. 4 is an explanatory view showing the first pay line,

FIG. 5 is an explanatory view showing the second pay line,

FIG. 6 is an explanatory view showing the third pay line,

FIG. 7 is an explanatory view showing a message to guide an executive instruction for conducting a substitution display,

FIG. 8 is a perspective view of a slot machine according to the first embodiment,

FIG. 9 is a front view of a control panel in the embodiment,

FIG. 10 is a block diagram schematically showing a control system of the slot machine of the embodiment,

FIG. 11 is a block diagram showing a liquid crystal drive circuit of liquid crystal displays in the embodiment,

FIG. 12 is an explanatory view schematically showing an example of symbol columns variably displayed on variable display portions in a base game conducted in the slot machine of the embodiment,

FIG. 13 is an explanatory view showing winning symbol combinations and payouts thereof in the embodiment

FIG. 14 is an explanatory view showing a lottery table of stop display symbols in the embodiment,

FIG. 15 is an explanatory view showing stop display areas of five variable display portions in the embodiment,

FIG. 16 is a flowchart of a main process program conducted in the slot machine of the embodiment,

FIG. 17 is a flowchart of a start acceptance process program conducted in the slot machine of the embodiment,

FIG. 18 is a flowchart of a lottery process program conducted in the slot machine of the embodiment,

FIG. 19 is a flowchart of a base game process program conducted in the slot machine of the embodiment,

FIG. 20 is a flowchart of a bonus game process program conducted in the slot machine of the embodiment,

FIG. 21 is an explanatory view showing a lottery table of the stop display symbols in the embodiment,

FIG. 22 is an explanatory view schematically showing an example of symbol columns variably displayed on the variable display portions in a bonus game conducted in the slot machine of the embodiment,

FIG. 23 is a flowchart of a lottery process program conducted in the slot machine of the embodiment, and

FIG. 24 is a flowchart of a base game process program conducted in the slot machine of the embodiment.

### DETAILED DESCRIPTION OF THE PREFERRED EMBODIMENTS

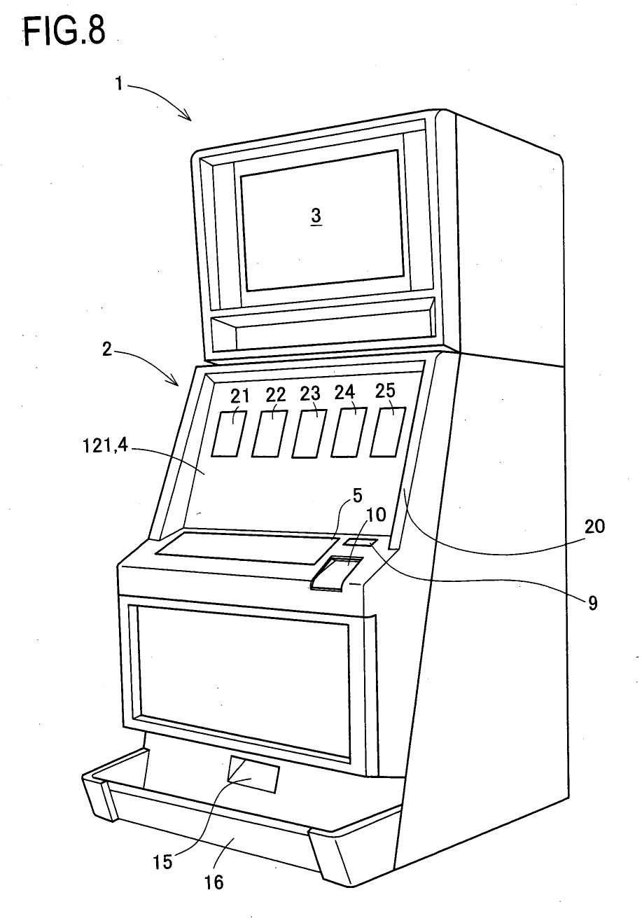

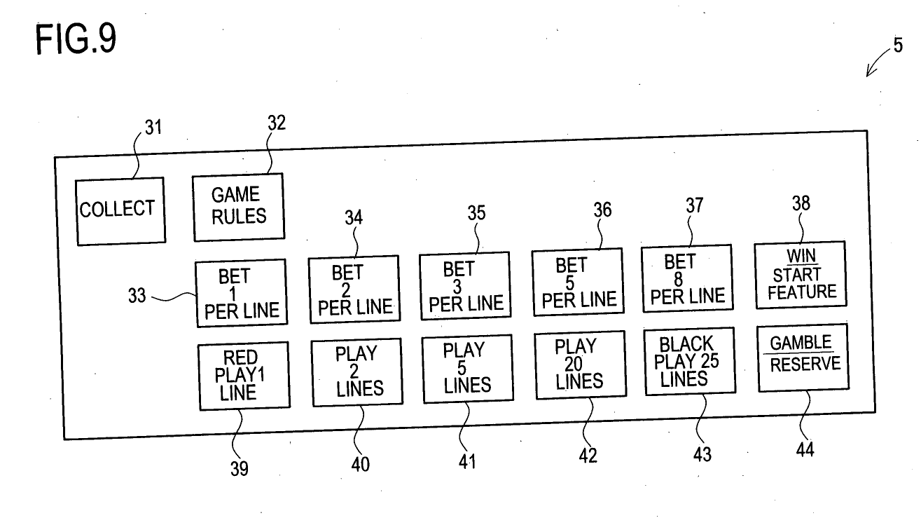

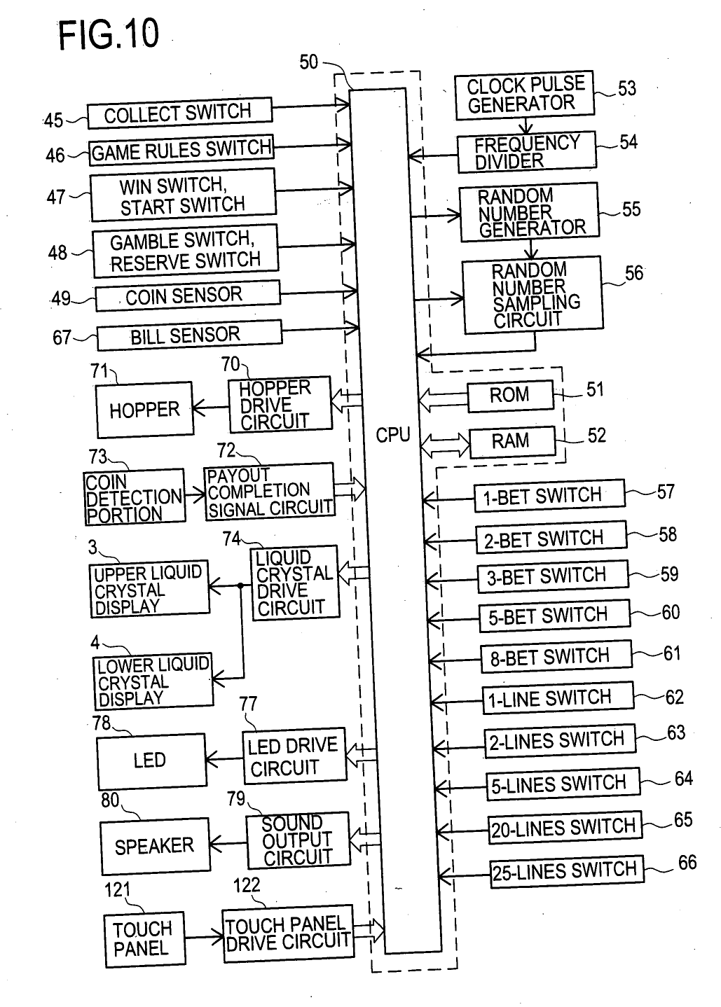

Hereinafter, concerning with a gaming machine according to the present invention, embodiments embodying the present invention in a slot machine will be described in detail with reference to the drawings. First, an outline construction of the slot machine according to the embodiment will be described with reference to FIGS. 8 to 10. FIG. 8 is a perspective view of the slot machine. FIG. 9 is a front view of a control panel. FIG. 10 is a block diagram schematically showing a control system of the slot machine.

In FIG. 8, the slot machine 1 has a cabinet 2 which forms whole construction of the slot machine 1. At an upper position of a front plane of the cabinet 2, an upper liquid crystal display 3 is arranged and a lower liquid crystal display 4 is arranged on a device front panel 20 which is arranged at a center position of the front plane of the cabinet 2. Here, both the upper liquid crystal display 3 and the lower liquid crystal display 4 are constructed from liquid crystal display generally used. On the upper liquid crystal display 3, it is indicated information concerning with a game such as methods, kinds of winning symbol combinations and payouts corresponding thereto and various effects. And on a surface of the lower liquid crystal display 4, credits are displayed and five variable display portions 21, 22, 23, 24 and 25 are basically displayed as shown in FIG. 8. On each of the variable display portion 21, 22, 23, 24 and 25, various symbols are variably displayed while being scrolled (hereinafter, called as “scroll display”) from an upper direction toward a lower direction, thereafter stopped and displayed.

Therefore, in the slot machine 1 of the embodiment, a slot game (there exist a base game and a bonus game) is conducted through a video reels which are realized by displaying variable display portions 21 to 25 on the lower liquid crystal display 4.

In the slot game (there exist a base game and a bonus game), there exist three symbols stopped and displayed on each of the variable display portions 21 to 25.

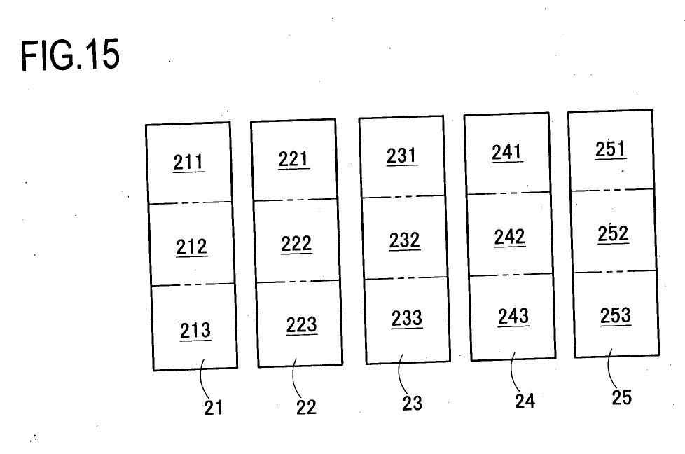

That is to say, as shown in FIG. 15, the variable display portions 21 to 25 are divided into first stop areas 211, 221, 231, 241, 251, second stop areas 212, 222, 232, 242, 252, and third stop areas 213, 223, 233, 243, 253. And the symbols are respectively stopped and displayed on the stop areas 211˜213, 221˜223, 231˜233, 241˜243, 251˜253.

And in this slot game (base game and bonus game), there exist twenty-five pay lines, each spanning five stop areas among the stop areas 211˜213, 221˜223, 231˜233, 241˜243, 251˜253. If each of the pay lines is activated and specific symbols are aligned with a specific display mode along the activated pay line when the symbols are stopped and displayed, a predetermined payout is given to the player.

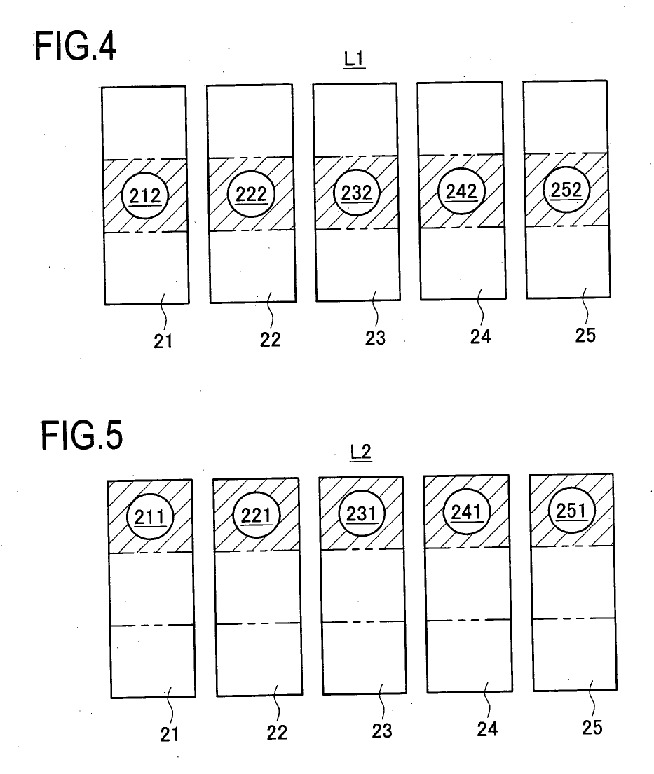

Here, for convenience sake of explanation, three pay lines among twenty-five pay lines will be concretely explained with reference to FIGS. 4 to 6. FIGS. 4 to 6 are explanatory views in each of which one pay line is indicated by portions with diagonal lines.

That is to say, as shown by portions with diagonal lines in FIG. 4, the first pay line L1 is formed from the second stop display portions 212, 222, 232, 242 and 252.

An as shown by portions with diagonal lines in FIG. 5, the second pay line L2 is formed from the first stop display portions 211, 221, 231, 241 and 251.

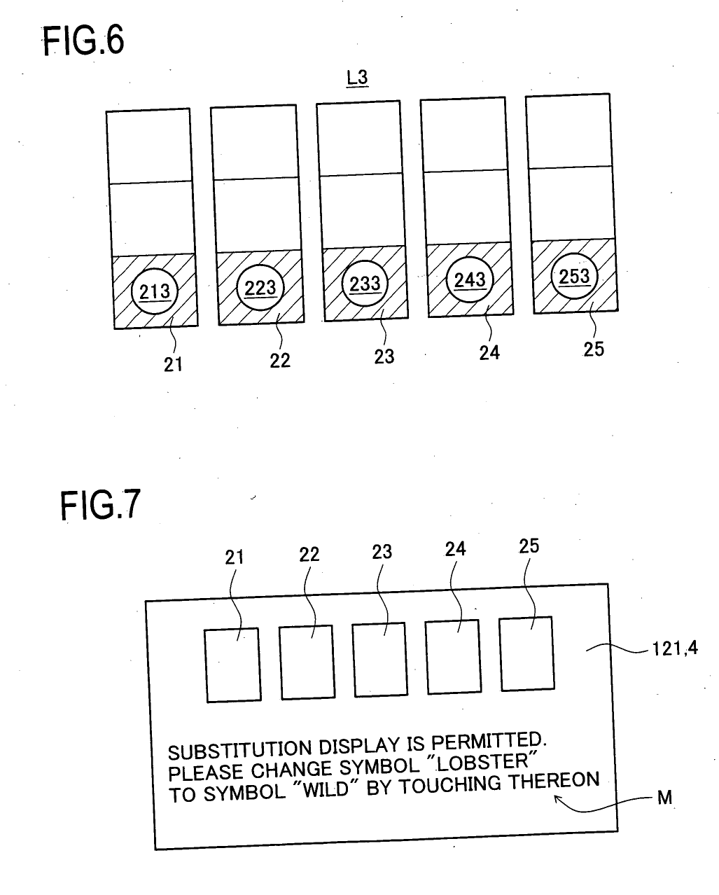

Further, as shown by portions with diagonal lines in FIG. 6, the third pay line L3 is formed from the third stop display portions 2213, 223, 233, 243 and 253.

Here, the pay line (s) activated among the 25 pay lines is/are called as “activated pay line (s)”

Back to FIG. 8, at an lower position of the lower liquid crystal display 4, a control panel 5 which is projected forward is formed. In the control panel 5 as shown in FIG. 9, a COLLECT button 31 and a GAME RULES button 32 are arranged in an upper step from the most left side, and a BET 1 PER LINE button 33, a BET 2 PER LINE button 34, a BET 3 PER LINE button 35, a BET 5 PER LINE button 36, a BET 8 PER LINE button 37 and a WIN START FEATURE button 38 are arranged in a middle step from the most left side. Further, a RED PLAY 1 LINE button 39, a PLAY 2 LINES button 40, a PLAY 5 LINES button 41, a PLAY 20 LINES button 42, a BLACK PLAY 25 LINES button 43 and a GAMBLE RESERVE button 44 are arranged in a lower step from the most left side. And as shown in FIG. 8, at the right side of the control panel 5, a coin insertion slot 9 and a bill insertion portion 10 are provided.

Here, the COLLECT button 31 is a button which is pressed when the base game is terminated, and when the COLLECT button 31 is pressed, coins equal to the credits obtained in the game are paid out from a coin payout opening 15 to a coin tray 16. To the COLLECT button 31, a COLLECT switch 45 is attached and a switch signal is output to a CPU 50 from the COLLECT switch 45 on the basis of press of the COLLECT button 31 (see FIG. 10).

The GAME RULES button 32 is a button which is pressed if operation methods of the game cannot be understood, and when the GAME RULES button 32 is pressed, various help information is displayed on the upper liquid crystal display 3 or the lower liquid crystal display 4. To the GAME RULES button 32, a GAME RULES switch 46 is attached and a switch signal is output to the CPU 50 from the GAME RULES switch 46 on the basis of press of the GAME RULES button 32 (see FIG. 10).

To the coin insertion slot 9, a coin sensor 49 is arranged and when a coin is inserted in the coin insertion slot 9, a coin detection signal is output to the CPU 50 through the coin sensor 49 (see FIG. 10) and credit corresponding to the inserted coin is added. And to the bill insertion portion 10, a bill sensor 67 is arranged and when a bill is inserted in the bill insertion portion 10, a bill detection signal is output to the CPU 50 through the bill sensor 67 (see FIG. 10), and credit corresponding to the inserted bill is added.

The BET 1 PER LINE button 33 is a button to bet one credit to each of the activated pay lines every one press thereof. To this BET 1 PER LINE button 33, a 1-BET switch 57 is attached and when the BET 1 PER LINE button 33 is pressed, a switch signal is output to the CPU 50 from the 1-BET switch 57 (see FIG. 10). The BET 2 PER LINE button 34 is a button to start the game with 2 bets against each of the activated pay lines on the basis of press thereof. To the BET 2 PER LINE button 34, a 2-BET switch 58 is attached and when the BET 2 PER LINE button 34 is pressed, a switch signal is output to the CPU 50 from the 2-BET switch 58 (see FIG. 10).

The BET 3 PER LINE button 35 is a button to start the game wit 3 bets against each of the activated pay lines on the basis of press thereof. To the BET 3 PER LINE button 35, a 3-BET switch 59 is attached and when the BET 3 PER LINE button 35 is pressed, a switch signal is output to the CPU 50 from the 3-BET switch 59 (see FIG. 10). And the BET 5 PER LINE button 36 is a button to start the game with 5 bets against each of the activated pay lines on the basis of press thereof. To the BET 5 PER LINE button 36, a 5-BET switch 60 is attached and when the BET 5 PER LINE button 36 is pressed, a switch signal is output to the CPU from the 5-BET switch 60 (see FIG. 10).

The BET 8 PER LINE button 37 is a button to start the game with 8 bets against each of the activated pay lines on the basis of press thereof. To the BET 8 PER LINE button 37, a 8-BET switch 61 is attached and when the BET 8 PER LINE switch 37 is pressed, a switch signal is output to the CPU 50 from the 8-BET switch 61 (see FIG. 10). Therefore, there will exist 1 bet, 2 bets, 3 bets, 5 bets and 8 bets as the bet number which can be betted by press of the BET 1 PER LINE button 33, the BET 2 PER LINE button 34, the BET 3 PER LINE button 35, the BET 5 PER LINE button 36 and the BET 8 PER LINE button 37.

The WIN START FEATURE button 38 is a button to start a bonus game or add the payout obtained in the bonus game to the credit on the basis of press thereof. To the WIN START FEATURE button 38, a WIN START switch 47 is attached and when the WIN START FEATURE button 38 is pressed, a switch signal is output to the CPU 50 from the WIN START switch 47 (see FIG. 10).

The RED PLAY 1 LINE button 39 is a button to start the game while retaining the number of the activated pay line to “1” on the basis of press thereof. To the RED PLAY 1 LINE button 39, a 1-LINE switch 62 is attached and when the RED PLAY 1 LINE button 39 is pressed, a switch signal is output to the CPU 50 from the 1-LINE switch 62 (see FIG. 10). And the PLAY 2 LINES button 40 is a button to start the game while retaining the number of the activated pay line to “2” on the basis of press thereof. To the PLAY 2 LINES button 49, a 2-LINES switch 63 is attached and when the PLAY 2 LINES button 40 is pressed, a switch signal is output to the CPU 50 from the 2-LINES switch 63 (see FIG. 10).

The PLAY 5 LINES button 41 is a button to start the game while retaining the number of the activated pay line to “5” on the basis of press thereof. To the PLAY 5 LINES button 41, a 5-LINES switch 64 is attached and when the PLAY 5 LINES button 41 is pressed, a switch signal is output to the CPU 50 from the 5-LINES switch 64 (see FIG. 10). And the PLAY 20 LINES button 42 is a button to start the game while retaining the number of the activated pay line to “20” on the basis of press thereof. To the PLAY 20 LINES button 42, a 20-LINES switch 65 is attached and when the PLAY 20 LINES button 42 is pressed, a switch signal is output to the CPU 50 from the 20-LINES switch 65 (see FIG. 10).

The BLACK PLAY 25 LINES button 43 is a button to start the game while retaining the number of the activated pay line to “25” on the basis of press thereof. To the BLACK PLAY 25 LINES button 43, a 25-LINES switch 66 is attached and when the BLACK PLAY 25 LINES button 43 is pressed, a switch signal is output to the CPU 50 from the 25-LINES switch 66 (see FIG. 10).

When the RED PLAY 1 LINE button 39 is pressed, the pay line L1 shown in FIG. 4 is activated. And when the PLAY 2 LINES button 40 is pressed, both the pay line L1 and the pay line L2 shown in FIGS. 4 and 5 are activated. And when the PLAY 5 LINES button 41 is pressed, total five pay lines of three pay lines L˜L3 shown FIGS. 4 to 6 and two pay lines (not shown) are activated. And when the PLAY 20 LINES button 42 is pressed, total twenty pay lines of three pay lines L1˜L3 and seventeen pay lines (not shown) are activated. And when the BLACK PLAY 25 LINES button 43 is pressed, total twenty-five pay lines of three pay lines L1˜L3 and twenty-two pay lines (not shown) are activated.

Therefore, there will exist “1” pay line, “2” pay lines, “5” pay lines, “20” pay lines and “25” pay lines as the number of the activated pay lines which can be determined by press of the RED PLAY 1 LINE button 39, the PLAY 2 LINES button 49, the PLAY 5 LINES button 41, the PLAY 20 LINES button 42, the BLACK PLAY 25 LINES button 43.

And each of the RED PLAY 1 LINE button 39, the PLAY 2 LINES button 49, the PLAY 5 LINES button 41, the PLAY 20 LINES button 42 and the BLACK PLAY 25 LINES button 43 is a button to start the game with the present bet number and the number of the activated pay lines and to start variable display of the symbols on each of the variable display portions 21 to 25 in the lower liquid crystal display 4.

Here, the RED PLAY 1 LINE button 39 and the BLACK PLAY 25 LINES button 43 are also used for selecting red or black in the double down game which is conducted by using the credit obtained in the bonus game.

The GAMBLE RESERVE button 44 is a button to be pressed when the player leaves the seat and to shift to the double down game after the bonus game is terminated. To the GAMBLE RESERVE button 44, a GAMBLE •RESERVE switch 48 is attached and when the GAMBLE RESERVE button 44 is pressed, a switch signal is output to the CPU 50 from the GAMBLE •RESERVE switch 48 (see FIG. 10).

And at a lower position of the cabinet 2, a coin payout opening 15 is formed and a coin tray 16 for receiving coins paid out from the coin payout opening 15 is provided. Within the coin payout opening 15 it is arranged a coin detection portion 73 (mentioned later) which is constructed from sensors and the like (see FIG. 10). And the coin detection portion 73 counts the number of coins paid out from the coin payout opening 15.

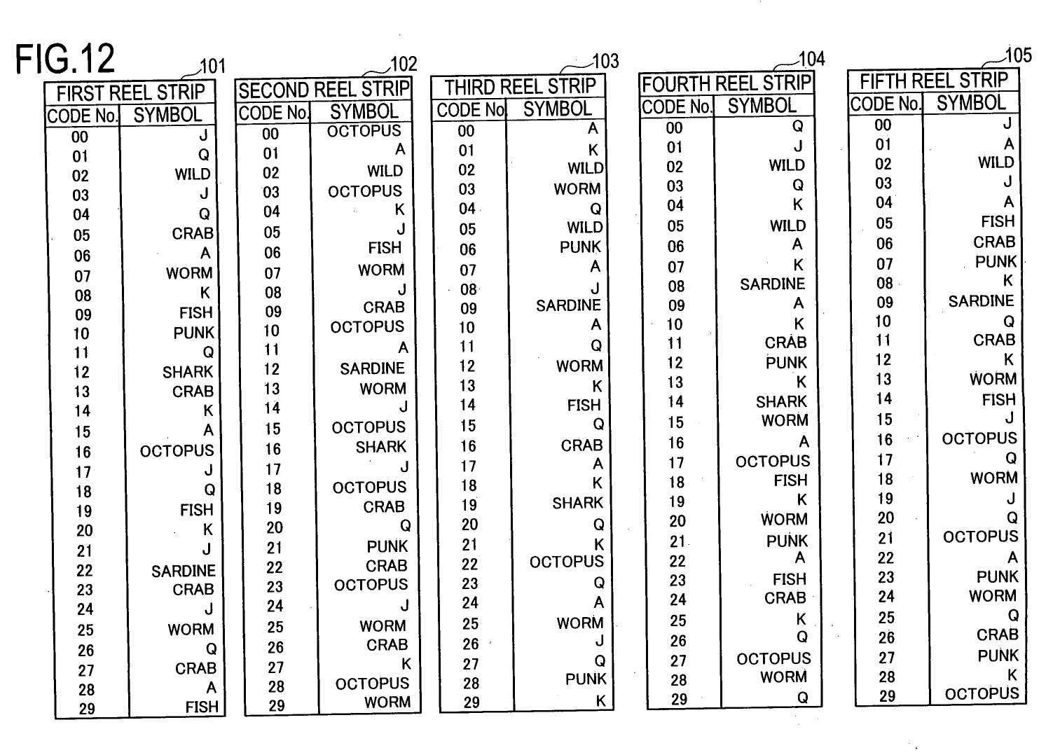

Next, with reference to FIG. 12, it will be described the symbol columns which are variably displayed while being scrolled on each of the variable display portions 21 to 25, the symbol columns being displayed on the lower liquid crystal display 4 in the base game. In FIG. 12, the symbol column indicated by a first reel strip 101 corresponds to a symbol column variably displayed on the variable display portion 21, the symbol column indicated by a second reel strip 102 corresponds to a symbol column variably displayed on the display portion 22, the symbol column indicated by a third reel strip 103 corresponds to a symbol column variably displayed on the variable display portion 23, the symbol column indicated by a fourth reel strip 104 corresponds to a symbol column variably displayed on the variable display portion 24 and the symbol column indicated by a fifth reel strip 105 corresponds to a symbol column variably displayed on the variable display portion 25.

Here, the symbol columns respectively indicated by the first to fifth reel strips 101 to 105 have different symbol columns from each other and each symbol column is constructed from 12 symbols by voluntarily combining “WILD”, “SHARK”, “FISH”, “PUNK”, “OCTOPUS”, “CRAB”, “WORM”, “A”, “K”, “Q”, “J” and “SARDINE”. Here, although “SHARK”, “FISH”, “PUNK”, “OCTOPUS”, “CRAB”, “WORM”, “SARDINE” are not shown, each symbol shows a shark, a fish, a person having a guitar, an octopus, a crab, a worm and a sardine, respectively. And each of “WILD”, “A”, “K”, “Q” and “J” shows a symbol of English character (s), respectively.

Further, “SARDINE” is a scatter symbol to shift to the bonus game as mentioned later and in a case that more than three “SARDINE” symbols are totally displayed on the variable display portions 21 to 25, the game state can be shifted to the bonus game.

And “WILD” is an almighty symbol which can be substituted for any of “SHARK”, “FISH”, “PUNK”, “OCTOPUS”, “CRAB”, “WORM”, “A”, “K”, “Q” and “J”. However, “WILD” cannot be substituted for “SARDINE” which is the scatter symbol.

Here, in a case that the symbol columns indicated by the first to fifth reel strips 101 to 105 are scrolled on the variable display portions 21 to 25 and thereafter stopped and displayed, three symbols are stopped and displayed in each variable display portion, as mentioned in the above. And various winning symbol combinations are preset based on plural kinds of symbol combinations and when the symbol combination corresponding to the winning symbol combination is stopped on the activated pay line, the payout is added to the credit corresponding to the winning symbol combination. This point is as same as that in the convention slot machine, thus explanation thereof will be omitted.

Next, it will be described a construction of control system in the slot machine 1 with reference to FIG. 10. FIG. 10 is a block diagram schematically showing a control system of the slot machine 1.

In FIG. 10, the control system of the slot machine 1 is basically constructed from a CPU 50, and a ROM 51 and a RAM 52 are connected to the CPU 50. In the ROM 51, a main process program mentioned later, a base game process program, a bonus game process program, a lottery table used when it is conducted lottery to determine the symbols which are stopped and displayed in the base game, a lottery table used when it is conducted lottery to determine the symbols which are stopped and displayed in the bonus game, and the other various programs necessary for control of the slot machine 1 and data tables. And the RAM 52 is a memory to temporarily store various data calculated by the CPU 50.

And to the CPU 50, a clock pulse generator 53 for generating standard clock pulses and a frequency divider 54 are connected, and a random number generator 55 for generating random numbers and a random number sampling circuit 56 are also connected. The random number sampled through the random number sampling circuit 56 is utilized in various lotteries of the winning symbol combinations and the like. Further, to the CPU 50, the COLLECT switch 45 attached to the COLLECT button 31, the GAME-RULES switch 46 attached to the GAME RULES button 32, the 1-BET switch 57 attached to the BET 1 PER LINE button 33, the 2-BET switch 58 attached to the BET 2 PER LINES button 34, the 3-BET switch 59 attached to the BET 3 PER LINES button 35, the 5-BET switch 60 attached to the BET 5 PER LINES button 36, the 8-BET switch 60 attached to the BET 8 PER LINES button 37, the WIN START switch 47 attached to the WIN START FEATURE button 38, the 1-LINE switch 62 attached to the RED PLAY 1 LINE button 39, the 2-LINES switch 63 attached to the PLAY 2 LINES button 40, the 5-LINES switch 64 attached to the PLAY 5 LINES button 41, the 20-LINES switch 65 attached to the PLAY 20 LINES button 42, the 25-LINES switch 66 attached to the BLACK PLAY 25 LINES button 43 and the GAMBLE •RESERVE switch 48 attached to the GAMBLE RESERVE button 44 are connected, respectively. The CPU 50 conducts control to execute various operations each of which corresponds to each button, based on the switch signal output from each switch by press thereof.

Further, to the CPU 50, the coin sensor 49 arranged in the coin insertion slot 9 and the bill sensor 67 arranged in the bill insertion portion 10 are respectively connected. The coin sensor 49 detects coins inserted from the coin insertion slot 9 and the CPU 50 calculates the number of inserted coins based on the coin detection signal output from the coin sensor 49. The bill sensor 67 detects kinds and sum of the bill inserted from the bill insertion portion 10 and the CPU 50 calculates the credit number equal to the sum of bill, based on the bill detection signal output from the bill sensor 67.

To the CPU 50, a hopper 71 is connected through a hopper drive circuit 70. When a drive signal is output to the hopper drive circuit 70 from the CPU 50, the hopper 71 pays out a predetermined number of coins from the coin payout opening 15.

And to the CPU 50, a coin detection portion 73 is connected through a payout completion signal circuit 72. The coin detection portion 73 is arranged in the coin payout opening 15 and when the coin detection portion 73 detects that a predetermined number of coins are paid out from the coin payout opening 15, a coin payout detection signal is output to the payout completion signal circuit 72 from the coin detection portion 73, thereby the payout completion signal circuit 72 outputs a payout completion signal to the CPU 50. Further, to the CPU 50, the upper liquid crystal display 3 and the lower liquid crystal display 4 are connected through a liquid crystal drive circuit 74, and the upper liquid crystal display 3 and the lower liquid crystal display 4 are controlled by the CPU 50.

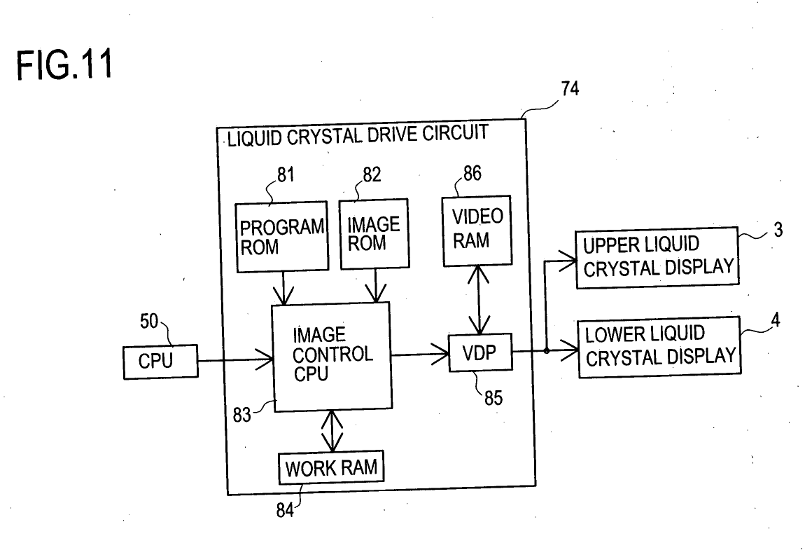

Here, as shown in FIG. 11, the liquid crystal drive circuit 74 is constructed from a program ROM 81, an image ROM 82, an image control CPU 83, a work RAM 84, a VDP (video display processor) 85 and a video RAM 68. And in the program ROM 81, there are stored an image control program for controlling display of the upper liquid crystal display 3 and the lower liquid crystal display 4 and various selection tables. And in the image ROM 82, for example, there are stored dot data for forming images of the symbol columns indicated by the first to fifth reel strips 101 to 105 in FIG. 12 and the symbol “LOBSTER” mentioned later, such images being displayed on the lower liquid crystal display 4 (or variable display portions 21 to 25). And the image control CPU 83 determines the images displayed on the upper liquid crystal display 3 and the lower liquid crystal display 4 among the dot data stored beforehand in the image ROM 82, according to the image control program stored beforehand in the program ROM 81 based on parameters set by the CPU 50. Further, the work RAM 84 functions as temporary memory when the image control program is executed by the image control CPU 83. And the VDP 85 forms images corresponding to display contents determined by the image control CPU 83 and outputs such images to the upper liquid crystal display 3 and the lower liquid crystal display 4. Thereby, for example, the symbol columns indicated by the first to fifth reel strips 101 to 105 are scrolled and displayed on the lower liquid crystal display 4 (or the variable display portions 21 to 25). Here, the video RAM 86 functions as temporary memory when images are formed by the VDP 85.

And to the CPU 50, LEDs 78 are connected through a LED drive circuit 77. Many LEDs 78 are arranged on the front plane of the slot machine 1 and are controlled so as to turn on or turn off by the LED drive circuit 77 based on the drive signal from the CPU 50, when various effects are done. Further, a sound output circuit 79 and a speaker 80 are connected to the CPU 50 and the speaker 80 produces various effect sounds when various effects are conducted based on the output signal from the sound output circuit 79.

And to the CPU 50, a touch panel 121 is connected through a touch panel drive circuit 122. The touch panel 121 is provided on the image plane of the lower liquid crystal display 4, and when the player touches within any of the variable display portions 21 to 25, it is recognized through the touch panel 121 not only the variable display portion which is touched among the variable display portions 21 to 25 but also the stop display area which is touched among the first stop display areas 211, 221, 231, 241, 251, the second stop display portions 212, 222, 232, 242, 252 and the third stop display portions 213, 223, 233, 243, 253.

That is to say, the touch panel 121 can recognize the variable display portion which is touched among the variable display portions 21 to 25, based on coordinate information of the portion which is touched by the player, through the touch panel drive circuit 122.

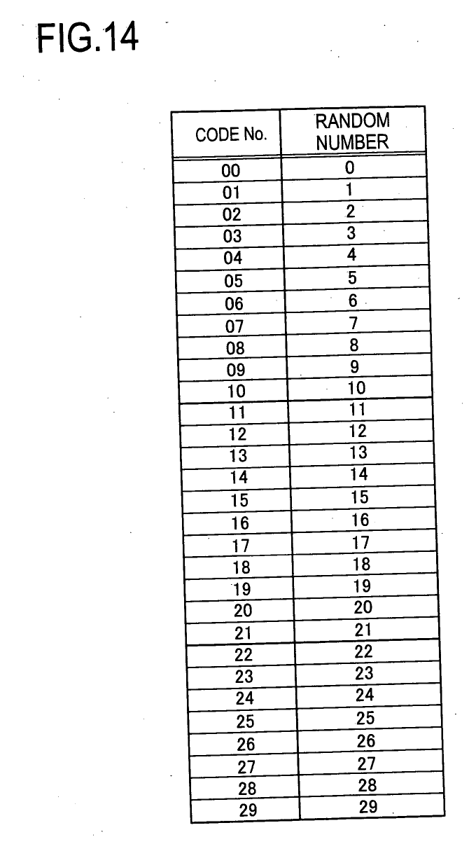

Here, it will be described with reference to FIG. 14 the lottery table which is used when the symbols stopped and displayed on the activated pay line L1 shown in FIG. 4 are determined, when the base game is conducted by using five variable display portions 21 to 25 in the slot machine 1. FIG. 14 is an explanatory view showing a lottery table of the stop display symbols used when the base game is conducted by utilizing five variable display portions 21 to 25.

The symbols stopped and displayed on the activated pay line constructed from the second stop display areas 212, 222, 232, 242 and 252 in the variable display portions 21 to 25 are determined every each of the variable display portions 21 to 25. In order to realize this, code Nos. “00″˜“29” are respectively allotted to the symbol in each symbol column indicated by the first to fifth reel strips 101 to 105 as shown in FIG. 12, in order of the upper most symbol. And the lottery table shown in FIG. 14 is provided beforehand. Further, five random numbers are sampled by the random number sampling circuit 56 so as to correspond to each of the variable display portions 21 to 25.

Hereinafter, the symbol column indicated by the first reel strip 101 in FIG. 12 will be described. The symbols in the symbol column are scrolled on the variable display portion 21. At that time, if the random number sampled by the random number sampling circuit 56 is “0”, the symbol “J” (English character) allotted to the code No. “00” is stopped and displayed on the activated pay line, if the random number is “1”, the symbol “Q” (English character) allotted to the code No “01” is stopped and displayed on the activated pay line, if the random number is “2”, the symbol “WILD” allotted to the code No. “02” is stopped and displayed on the activated pay line, if the random number is “3”, the symbol “J” (English character) allotted to the code No. “03” is stopped and displayed on the activated pay line, if the random number is “4”, the symbol “Q” (English character) allotted to the code No. “04” is stopped and displayed on the activated pay line, if the random number is “5”, the symbol “CRAB” allotted to the code No. “05” is stopped and displayed on the activated pay line, if the random number is “6”, the symbol “A” (English character) allotted to the code No. “06” is stopped and displayed on the activated pay line, if the random number is “7”, the symbol “WORM” allotted to the code No. “07” is stopped and displayed on the activated pay line, if the random number is “8”, the symbol “K” (English character) allotted to the code No. “08” is stopped and displayed on the activated pay line, if the random number is “9”, the symbol “FISH” allotted to the code No. “09” is stopped and displayed on the activated pay line, and if the random number is “10”, the symbol “PUNK” allotted to the code No. “10” is stopped and displayed on the activated pay line. And if the random number is “11”, the symbol “Q” (English character) allotted to the code No. “11” is stopped and displayed on the activated pay line, if the random number is “12”, the symbol “SHARK” allotted to the code No. “12” is stopped and displayed on the activated pay line, if the random number is “13”, the symbol “CRAB” allotted to the code No. “13” is stopped and displayed on the activated pay line, if the random number is “14”, the symbol “K” (English character) allotted to the code No. “14” is stopped and displayed on the activated pay line, if the random number is “15”, the symbol “A” (English character) allotted to the code No. “15” is stopped and displayed on the activated pay line, if the random number is “16”, the symbol “OCTOPUS” allotted to the code No. “16” is stopped and displayed on the activated pay line, if the random number is “17”, the symbol “J” (English character) allotted to the code No. “17” is stopped and displayed on the activated pay line, if the random number is “18”, the symbol “Q” (English character) allotted to the code No. “18” is stopped and displayed on the activated pay line, and if the random number is “19”, the symbol “FISH” allotted to the code No. “19” is stopped and displayed on the activated pay line.

And if the random number is “20”, the symbol “K” (English character) allotted to the code No. “20” is stopped and displayed on the activated pay line, if the random number is “21”, the symbol “J” (English character) allotted to the code No. “21” is stopped and displayed on the activated pay line, if the random number is “22”, the symbol “SARDINE” allotted to the code No. “22” is stopped and displayed on the activated pay line, if the random number is “23”, the symbol “CRAB” allotted to the code No. “23” is stopped and displayed on the activated pay line, if the random number is “24”, the symbol “J” (English character) allotted to the code No. “24” is stopped and displayed on the activated pay line, if the random number is “25”, the symbol “WORM” allotted to the code No. “25” is stopped and displayed on the activated pay line, if the random number is “26”, the symbol “Q” (English character) allotted to the code No. “26” is stopped and displayed on the activated pay line, if the random number is “27”, the symbol “CRAB” allotted to the code No. “27” is stopped and displayed on the activated pay line, if the random number is “28”, the symbol “A” (English character) allotted to the code No. “28” is stopped and displayed on the activated pay line, and if the random number is “29”, the symbol “FISH” allotted to the code No. “29” is stopped and displayed on the activated pay line.

Here, as for the symbol column indicated by the second reel strip 102 in FIG. 12 the symbols of which are scrolled on the variable display portion 22, the symbol column indicated by the third reel strip 103 in FIG. 12 the symbols of which are scrolled on the variable display portion 23, the symbol column indicated by the fourth reel strip 104 in FIG. 12 the symbols of which are scrolled on the variable display portion 24 and the symbol column indicated by the fifth reel strip 105 in FIG. 12 the symbols of which are scrolled on the variable display portion 25, the above control is similarly conducted.

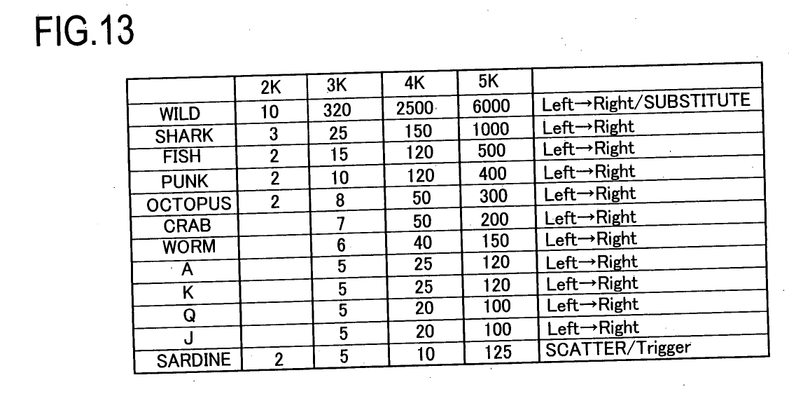

Next, with reference to FIG. 13, it will be described the winning symbol combinations and payouts thereof in a case that the base game is executed by using five variable display portions 21 to 25 in the slot machine 1. FIG. 13 is an explanatory view showing the winning symbol combinations and payouts thereof in a case that the base game is executed by using five variable display portions 21 to 25, and shows payouts in a case that the bet number is “1”. Therefore, if the bet number is “1”, the payout number shown in FIG. 13 is added to the credit, and if the bet number is more than “2”, the value obtained by multiplying the bet number with the payout number shown in FIG. 13 is added to the credit.

Here, concretely describing the winning symbol combinations and payouts thereof in the base game, as shown in FIG. 13, if the symbols “WILD” (shown in FIG. 13) are stopped and displayed in series along the activated pay line on the variable display portions 21 and 22 (if two symbols “WILD” appear in series from the left end (this case is called as “2K”)), the payout number “10” can be obtained. And if the symbols “WILD” are stopped and displayed in series along the activated pay line on the variable display portions 21 to 23 (if three symbols “WILD” appear in series from the left end (this case is called as “3K”)), the payout number “320” can be obtained.

Further, if the symbols “WILD” are stopped and displayed in series along the activated pay line on the variable display portions 21 to 24 (if four symbols “WILD” appear in series from the left end (this case is called as “4K”)), the payout number “2500” can be obtained. And if the symbols “WILD” are stopped and displayed in series along the activated pay line on the variable display portions 21 to 25 (if five symbols “WILD” appear in series from the left end (this case is called as “5K”)), the payout number “6000” can be obtained.

And as for the symbol “SHARK”, if the symbols “SHARK” are stopped and displayed in series along the activated pay line on the variable display portions 21 and 22 (if two symbols “SHARK” appear in series from the left end (this case is called as “2K”)), the payout number “3” can be obtained. And if the symbols “SHARK” are stopped and displayed in series along the activated pay line on the variable display portions 21 to 23 (if three symbols “SHARK” appear in series from the left end (this case is called as “3K”)), the payout number “25” can be obtained. Further, if the symbols “SHARK” are stopped and displayed in series along the activated pay line on the variable display portions 21 to 24 (if four symbols “SHARK” appear in series from the left end (this case is called as “4K”)), the payout number “150” can be obtained.

And if the symbols “SHARK” are stopped and displayed in series along the activated pay line on the variable display portions 21 to 25 (if five symbols “SHARK” appear in series from the left end (this case is called as “5K”)), the payout number “1000” can be obtained.

Here, as mentioned in the above, the symbol “WILD” can be substituted for the symbol “SHARK”.

And as for the symbol “FISH”, if the symbols “FISH” are stopped and displayed in series along the activated pay line on the variable display portions 21 and 22 (if two symbols “FISH” appear in series from the left end (this case is called as “2K”)), the payout number “2” can be obtained. And if the symbols “FISH” are stopped and displayed in series along the activated pay line on the variable display portions 21 to 23 (if three symbols “FISH” appear in series from the left end (this case is called as “3K”)), the payout number “15” can be obtained. Further, if the symbols “FISH” are stopped and displayed in series along the activated pay line on the variable display portions 21 to 24 (if four symbols “FISH” appear in series from the left end (this case is called as “4K”)), the payout number “120” can be obtained. And if the symbols “FISH” are stopped and displayed in series along the activated pay line on the variable display portions 21 to 25 (if five symbols “FISH” appear in series from the left end (this case is called as “5K”)), the payout number “500” can be obtained.

Here, as mentioned in the above, the symbol “WILD” can be substituted for the symbol “FISH”.

And as for the symbol “PUNK” (a person having a guitar), if the symbols “PUNK” are stopped and displayed in series along the activated pay line on the variable display portions 21 and 22 (if two symbols “PUNK” appear in series from the left end (this case is called as “2K”)), the payout number “2” can be obtained. And if the symbols “PUNK” are stopped and displayed in series along the activated pay line on the variable display portions 21 to 23 (if three symbols “PUNK” appear in series from the left end (this case is called as “3K”)), the payout number “10” can be obtained. Further, if the symbols “PUNK” are stopped and displayed in series along the activated pay line on the variable display portions 21 to 24 (if four symbols “PUNK” appear in series from the left end (this case is called as “4K”)), the payout number “120” can be obtained. And if the symbols “PUNK” are stopped and displayed in series along the activated pay line on the variable display portions 21 to 25 (if five symbols “PUNK” appear in series from the left end (this case is called as “5K”)), the payout number “400” can be obtained.

Here, as mentioned in the above, the symbol “WILD” can be substituted for the symbol “PUNK” (a person having a guitar).

And as for the symbol “OCTOPUS”, if the symbols “OCTOPUS” are stopped and displayed in series along the activated pay line on the variable display portions 21 and 22 (if two symbols “OCTOPUS” appear in series from the left end (this case is called as “2K”)), the payout number “2” can be obtained. And if the symbols “OCTOPUS” are stopped and displayed in series along the activated pay line on the variable display portions 21 to 23 (if three symbols “OCTOPUS” appear in series from the left end (this case is called as “3K”)), the payout number “8” can be obtained. Further, if the symbols “OCTOPUS” are stopped and displayed in series along the activated pay line on the variable display portions 21 to 24 (if four symbols “OCTOPUS” appear in series from the left end (this case is called as “4K”)), the payout number “50” can be obtained. And if the symbols “OCTOPUS” are stopped and displayed in series along the activated pay line on the variable display portions 21 to 25 (if five symbols “OCTOPUS” appear in series from the left end (this case is called as “5K”)), the payout number “300” can be obtained.

Here, as mentioned in the above, the symbol “WILD” can be substituted for the symbol “OCTOPUS”.

And as for the symbol “CRAB”, if the symbols “CRAB” are stopped and displayed in series along the activated pay line on the variable display portions 21 to 23 (if three symbols “CRAB” appear in series from the left end (this case is called as “3K”)), the payout number “7” can be obtained. Further, if the symbols “CRAB” are stopped and displayed in series along the activated pay line on the variable display portions 21 to 24 (if four symbols “CRAB” appear in series from the left end (this case is called as “4K”)), the payout number “50” can be obtained. And if the symbols “CRAB” are stopped and displayed in series along the activated pay line on the variable display portions 21 to 25 (if five symbols “CRAB” appear in series from the left end (this case is called as “5K”)), the payout number “200” can be obtained.

Here, as mentioned in the above, the symbol “WILD” can be substituted for the symbol “CRAB”.

And as for the symbol “WORM”, if the symbols “WORM” are stopped and displayed in series along the activated pay line on the variable display portions 21 to 23 (if three symbols “WORM” appear in series from the left end (this case is called as “3K”)), the payout number “6” can be obtained. Further, if the symbols “WORM” are stopped and displayed in series along the activated pay line on the variable display portions 21 to 24 (if four symbols “WORM” appear in series from the left end (this case is called as “4K”)), the payout number “40” can be obtained. And if the symbols “WORM” are stopped and displayed in series along the activated pay line on the variable display portions 21 to 25 (if five symbols “WORM” appear in series from the left end (this case is called as “5K”)), the payout number “150” can be obtained.

Here, as mentioned in the above, the symbol “WILD” can be substituted for the symbol “WORM”.

And as for the symbol “A” (English character), if the symbols “A” are stopped and displayed in series along the activated pay line on the variable display portions 21 to 23 (if three symbols “A” appear in series from the left end (this case is called as “3K”)), the payout number “5” can be obtained. Further, if the symbols “A” are stopped and displayed in series along the activated pay line on the variable display portions 21 to 24 (if four symbols “A” appear in series from the left end (this case is called as “4K”)), the payout number “25” can be obtained. And if the symbols “A” are stopped and displayed in series along the activated pay line on the variable display portions 21 to 25 (if five symbols “A” appear in series from the left end (this case is called as “5K”)), the payout number “120” can be obtained.

Here, as mentioned in the above, the symbol “WILD” can be substituted for the symbol “A (English character)”.

And as for the symbol “K” (English character), if the symbols “K” are stopped and displayed in series along the activated pay line on the variable display portions 21 to 23 (if three symbols “K” appear in series from the left end (this case is called as “3K”)), the payout number “5” can be obtained. Further, if the symbols “K” are stopped and displayed in series along the activated pay line on the variable display portions 21 to 24 (if four symbols “K” appear in series from the left end (this case is called as “4K”)), the payout number “25” can be obtained. And if the symbols “K” are stopped and displayed in series along the activated pay line on the variable display portions 21 to 25 (if five symbols “K” appear in series from the left end (this case is called as “5K”)), the payout number “120” can be obtained.

Here, as mentioned in the above, the symbol “WILD” can be substituted for the symbol “K (English character)”.

And as for the symbol “Q” (English character), if the symbols “Q” are stopped and displayed in series along the activated pay line on the variable display portions 21 to 23 (if three symbols “Q” appear in series from the left end (this case is called as “3K”)), the payout number “5” can be obtained. Further, if the symbols “Q” are stopped and displayed in series along the activated pay line on the variable display portions 21 to 24 (if four symbols “Q” appear in series from the left end (this case is called as “4K”)), the payout number “20” can be obtained. And if the symbols “Q” are stopped and displayed in series along the activated pay line on the variable display portions 21 to 25 (if five symbols “Q” appear in series from the left end (this case is called as “5K”)), the payout number “100” can be obtained.

Here, as mentioned in the above, the symbol “WILD” can be substituted for the symbol “Q (English character)”.

And as for the symbol “J” (English character), if the symbols “J” are stopped and displayed in series along the activated pay line on the variable display portions 21 to 23 (if three symbols “J” appear in series from the left end (this case is called as “3K”)), the payout number “5” can be obtained. Further, if the symbols “J” are stopped and displayed in series along the activated pay line on the variable display portions 21 to 24 (if four symbols “J” appear in series from the left end (this case is called as “4K”)), the payout number “20” can be obtained. And if the symbols “J” are stopped and displayed in series along the activated pay line on the variable display portions 21 to 25 (if five symbols “J” appear in series from the left end (this case is called as “5K”)), the payout number “100” can be obtained.

Here, as mentioned in the above, the symbol “WILD” can be substituted for the symbol “J (English character)”.

And in a case that the above payout is realized on plural activated pay lines, all payouts are added to the credit.

On the other hand, as for the symbol “SARDINE”, if two symbols “SARDINE” appear (are stopped and displayed) on the variable display portions 21 to 25 with no relation to the activated pay lines, that is, if the case “2K” is realized, the payout number “2” can be obtained. If three symbols “SARDINE” appear (are stopped and displayed) on the variable display portions 21 to 25 with no relation to the activated pay lines, that is, if the case “3K” is realized, the payout number “5” can be obtained.

And if four symbols “SARDINE” appear (are stopped and displayed) on the variable display portions 21 to 25 with no relation to the activated pay lines, that is, if the case “4K” is realized, the payout number “10” can be obtained. Further, if five symbols “SARDINE” appear (are stopped and displayed) on the variable display portions 21 to 25 with no relation to the activated pay lines, that is, if the case “5K” is realized, the payout number “125” can be obtained.

Here, concerning with only the payout obtained by the symbol “SARDINE”, the payout number calculated by multiplying the payout number shown in FIG. 13 with the total bet number (a product of the bet number and the number of activated pay line) is added to the credit. At that time, if it exists the payout other than the payout on the basis of the symbol “SARDINE”, such payout is also added to the credit.

And as for the symbol “SARDINE”, in a case that more than three symbols “SARDINE” are totally stopped and displayed on the variable display portions 21 to 25 with no relation to the activated pay lines, not only the above payout can be obtained but also the game state can be shifted to the bonus game.

Here, the bonus game is a game which is conducted after the base game is terminated, and in many cases the bonus game is generally more beneficial for the player. If the game state shifts to the bonus game, 15˜25 games can be continuously and automatically executed without betting any credits corresponding to a result of the lottery conducted when the game state shifts to the bonus game.

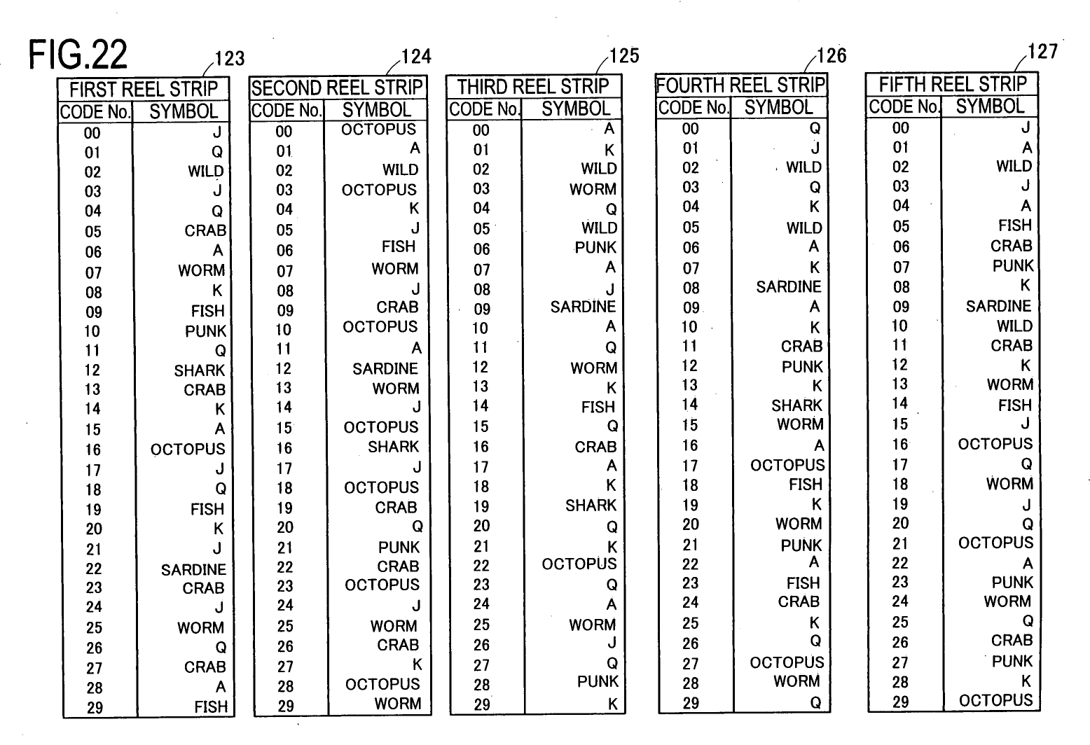

By the way, in the slot machine 1 according to the embodiment, when the bonus game is conducted, the symbol column variably displayed while being scrolled on the variable display portion 21 of the lower liquid crystal display 4 is the symbol column indicated by the first reel strip 123 shown in FIG. 22, the symbol column variably displayed while being scrolled on the variable display portion 22 of the lower liquid crystal display 4 is the symbol column indicated by the second reel strip 124 shown in FIG. 22, the symbol column variably displayed while being scrolled on the variable display portion 23 of the lower liquid crystal display 4 is the symbol column indicated by the third reel strip 125 shown in FIG. 22, the symbol column variably displayed while being scrolled on the variable display portion 24 of the lower liquid crystal display 4 is the symbol column indicated by the fourth reel strip 126 shown in FIG. 22 and the symbol column variably displayed while being scrolled on the variable display portion 25 of the lower liquid crystal display 4 is the symbol column indicated by the fifth reel strip 127 shown in FIG. 22.

Here, the symbol columns indicated by the reel strips 123 to 126 shown in FIG. 22 are as same as those indicated by the reel strips 101 to 104 shown in FIG. 12. On the other hand, the symbol column indicated by the reel strip 127 shown in FIG. 22 is substantially as same as the symbol column indicated by the reel strip 105 shown in FIG. 22, except for the symbol “WILD” allotted to the code No. “10”.

Here, as the bet number and the number of activated pay line in the bonus game, the bet number and the number of activated pay line set in the base game are utilized, respectively. And in the bonus game, although the winning symbol combinations and payouts thereof in the bonus game are as same as those in the base game, the symbol “SHARK” is regarded as the symbol “WILD” and if more than three symbols “SARDINE” totally appear (are totally stopped and displayed), the game state in the bonus game can be again shifted to the bonus game. Therefore, the player can obtain a lot of credits in many cases.

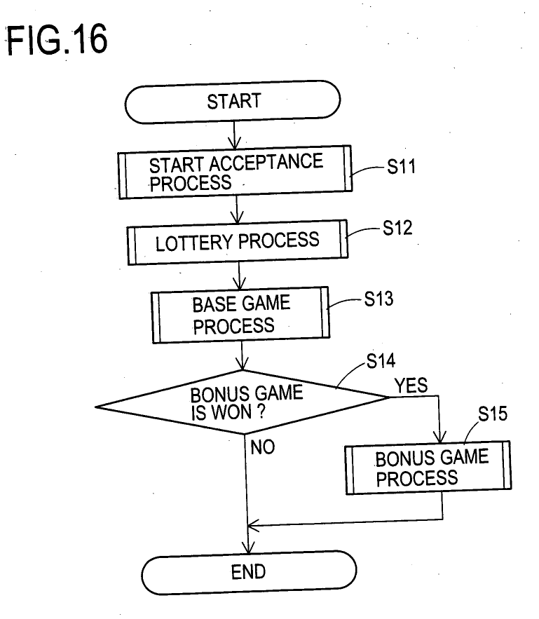

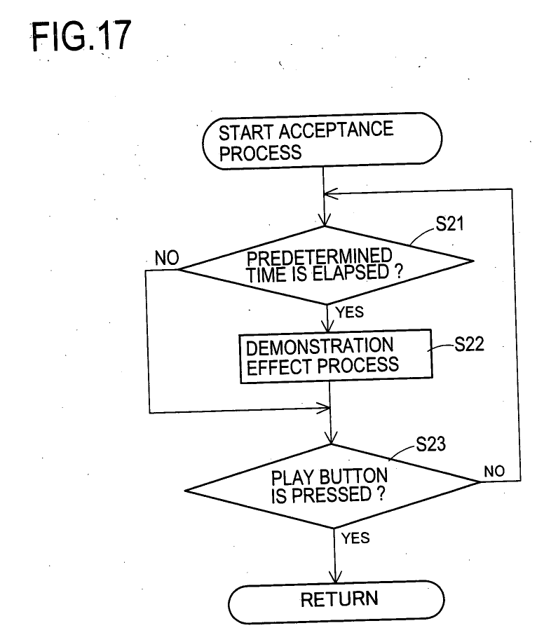

Next, the main process program executed in the slot machine 1 will be described with reference to FIG. 16. FIG. 16 is a flowchart of the main process program. In FIG. 16, at first, in step (abbreviated as “S” hereinafter) 11, a start acceptance process shown in FIG. 17 is executed. This process is a process for accepting the switch signal output from the 1-BET switch 57, the 2-BET switch 58, the 3-BET switch 59, the 5-BET switch 60, the 8-BET switch 61, the 1-LINE switch 62, the 2-LINES switch 63, the 5-LINES switch 64, the 20-LINES switch 65, the 25-LINES switch 66, based on operation of the BET 1 PER LINE button 33, the BET 2 PER LINES button 34, the BET 3 PER LINES button 35, the BET 5 PER LINES 36, the BET 8 PER LINES button 37, the RED PLAY 1 LINE button 39, the PLAY 2 LINES button 40, the PLAY 5 LINES button 41, the PLAY 20 LINES button 42 or the BLACK PLAY 25 LINES button 43. When the switch signal output from each switch is accepted, the game is started.

And in S12, a lottery process shown in FIG. 16 mentioned later is executed based on the switch signal output from the 1-LINE switch 62, the 2-LINES switch 63, the 5-LINES switch 64, the 20-LINES switch 65, the 25-LINES switch 66.

Here, if the bonus game is won, a repeat number of the bonus game is determined. In this case, for example, such repeat number is selected among 10˜25 games by a lottery.

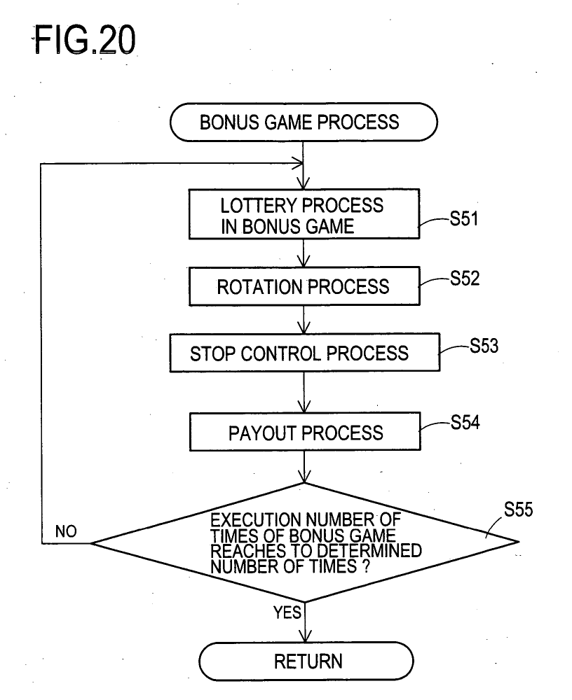

Next, in S13, a base game process shown in FIG. 20 mentioned later is executed. Thereafter, procedure shifts to S14 and it is determined whether or not the bonus game is won. Concretely, in the lottery process in S12, if more than three symbols “SARDINE” totally appear (are stopped and displayed) on the variable display portions 21 to 25 with no relation to the activated pay lines, the bonus game is won (S14: YES). Thereby, procedure shifts to S15 and the main process program is terminated after the bonus game process shown in FIG. 20 mentioned later is executed. On the other hand, in the lottery process of S12, if more than three symbols “SARDINE” does not totally appear (are not stopped and displayed) on the variable display portions 21 to 25 with no relation to the activated pay lines, the bonus game is not won (S14: NO), thereby the main process program is terminated.

Next, the start acceptance process program conducted in the slot machine 1 will be described with reference to FIG. 17. FIG. 17 is a flowchart of the start acceptance process program. In S11 of the main process program shown in FIG. 16, the start acceptance process is conducted. Here, to conduct this process, at first, procedure shifts to S21 of FIG. 17 and it is determined whether or not a predetermined time (for example, 15 seconds) is elapsed. Here, if it is determined that the predetermined time is not elapsed (S21: NO), procedure shifts to S23, and on the other hand, if it is determined that the predetermined time is elapsed (S21: YES), demonstration effect is done on the upper liquid crystal display 3 or the lower liquid crystal display 4 in S22, thereafter procedure shifts to S23. And in S23, it is determined whether or not operation of the RED PLAY 1 LINE button 39, the PLAY 2 LINES button 40, the PLAY 5 LINES button 41, the PLAY 20 LINES button 42 or the BLACK PLAY 25 LINES button 43 is done. Here, if it is determined that operation of the RED PLAY 1 LINE button 39 and the like is not done (S23: NO), procedure returns to S21 and the above procedures are repeated. On the other hand, if it is determined that operation of the RED PLAY 1 LINE button 39 and the like is done (S23: YES), procedure returns to the main process program of FIG. 36 and shifts to the lottery process in S12 even while the demonstration effect is done.

Here, in the determination process in S23, such determination in S23 may be conducted based on the other input signals other than the above operation signals.

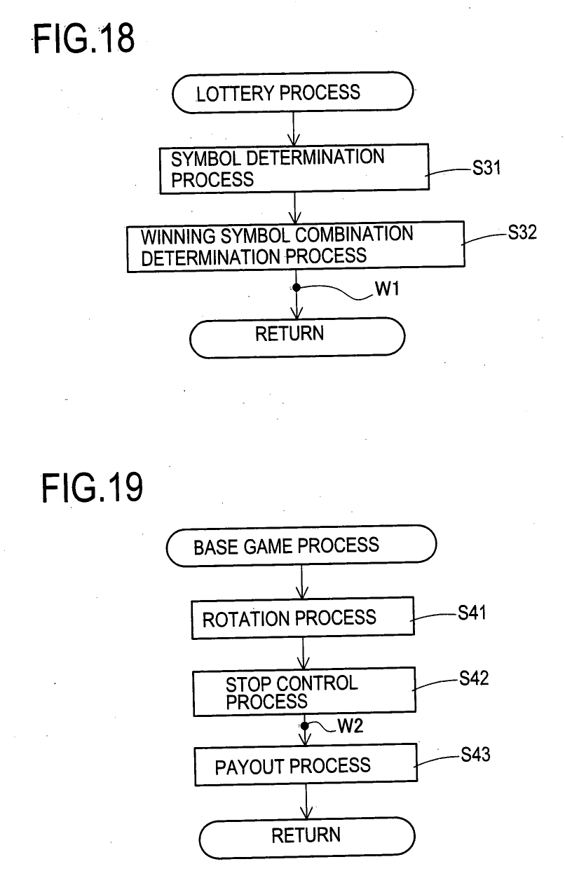

Next, the lottery process program executed in the slot machine 1 will be described with reference to FIG. 18. FIG. 18 is a flowchart of the lottery process program. In S12 of the main process program shown in FIG. 16, the lottery process is executed. To conduct this process, at first, procedure shifts to S31 of FIG. 18 and a symbol determination process is conducted. Here, the symbols stopped and displayed on the first activated pay line L1 in the base game are determined every each of the variable display portions 21 to 25. Concretely, as mentioned above, five random number values are sampled by the random number sampling circuit 56 so as to correspond to each of the variable display portions 21 to 25 and the symbols stopped and displayed are determined through the code Nos. based on the lottery table shown in FIG. 14. And if the symbols stopped and displayed on the activated pay line are determined, a determination process of the winning symbol combination is executed in S32, thereafter procedure returns to the main process program in FIG. 16 and shifts to the base game process in S13. Here, concretely speaking, in the determination process of the winning symbol combination, the winning symbol combination and the payout thereof are determined based on the table shown in FIG. 13 through the code No. obtained in S31, as mentioned.

Next, the base game process program executed in the slot machine 1 will be described with reference to FIG. 19. FIG. 19 is a flowchart of the base game process program. In S13 of the main process program shown in FIG. 16, the base game is conducted. To realized this, at first, in S41 of FIG. 19, scroll of each of the symbols is done on the variable display portions 21 to 25 based on the switch signal output from the 1-LINE switch 62, the 2-LINES switch 63, the 5-LINES switch 64, the 20-LINES switch 65 or the 25-LINES switch 66, the switch signal being accepted in S11 of FIG. 16.

And in S42, scroll of each of the symbols on the variable display portions 21 to 25 is stopped.

Further, in S43, according to the symbol combination corresponding to the winning symbol combination stopped and displayed on the variable display portions 21 to 25, the credit corresponding to the payout determined on the basis of the table shown in FIG. 13 is paid out. Here, after process in S43 is executed, procedure shifts to the main process program shown in FIG. 16 and shifts to the determination process in S14.

Next, the bonus game process program executed in the slot machine 1 will be described with reference to FIG. 20. FIG. 20 is a flowchart of the bonus game process program. In S14 of the main process program shown in FIG. 16, if it is determined that the bonus game is won (S14: YES), procedure shifts to S15 of FIG. 16 and the bonus game process is conducted. To realize this, at first, procedure shifts to S51 shown in FIG. 20 and the lottery process during the bonus game is executed. Here, in the bonus game, the symbols stopped and displayed on the first activated pay line L1 are determined every each of the variable display portions 21 to 25. Concretely, as mentioned, five random number values are sampled by the random number sampling circuit 56 so as to correspond to each of the variable display portions 21 to 25, and the symbols stopped and displayed are determined through the code Nos. based on the lottery table shown in FIG. 14. And if the symbols stopped and displayed on the pay line are determined, the winning symbol combination and the payout thereof are determined based on the table shown in FIG. 13 through the code Nos. Further, in the rotation process in S52, scroll of each of the symbols is automatically done on the variable display portions 21 to 25.

And in the stop control process in S53, scroll of each of the symbols on the variable display portions 21 to 25 is stopped.

Further, in the payout process in S54, according to the symbol combination corresponding to the winning symbol combination stopped and displayed on the variable display portions 21 to 25, the credit corresponding to the payout determined based on the table in FIG. 13 (however, the symbol “SHARK” is regarded as the symbol “WILD” (English characters)) is paid out.

Next, procedure shifts to S55 and it is determined whether or not the execution number of times of the bonus game reaches to the number of times determined in S12 of FIG. 16. At that time, if it is determined that the execution number of times of the bonus game does not reach to the number of times already determined in S12 of FIG. 16 (S55: NO), procedure returns to S51 and the above processes are repeated. On the other hand, if it is determined that the execution number of times of the bonus game reaches to the number of times already determined in S12 of FIG. 16 (S55: YES), the bonus game process program is terminated.

Here, if the bonus game is won in S51, the repeat number of times of the bonus game is determined again and the determined repeat number of times is added to the “number of times determined in S12 of FIG. 16” used in the determination process in S55. Thereby, when the bonus game is won during the bonus game, procedure can again shift to the bonus game. Concretely speaking, for example, in a case that procedure shifts to the bonus game with 20 number of times for the first time and the bonus game with 17 number of times is won in the twelfth bonus game, the bonus games are conducted in 25 times (20 times−12 times+17 times) thereafter.

And if the credit can be finally obtained in the bonus game, a double down game to bet the credit is executed after the bonus game is terminated. This double down game will be omitted.

As mentioned in the above, the CPU 50 functions as “game controller” when the main process program of FIG. 16 is executed.

By the way, in the slot machine 1 of the embodiment, there will be a case in which it is conducted the substitution display that, if the symbol “WILD” (English characters) is displayed in any of the stop display areas 211, 212, 213 of the variable display portion 21 during the base game, the symbol “LOBSTER” is displayed instead of the symbol “WILD”. When this substitution display is conducted, the symbol “LOBSTER” is substituted for the symbol “WILD” and thereafter the symbol “WILD” is displayed, based on that the player touches the symbol “LOBSTER” displayed in any of the stop display areas 211, 212, 213 of the variable display portion 21.

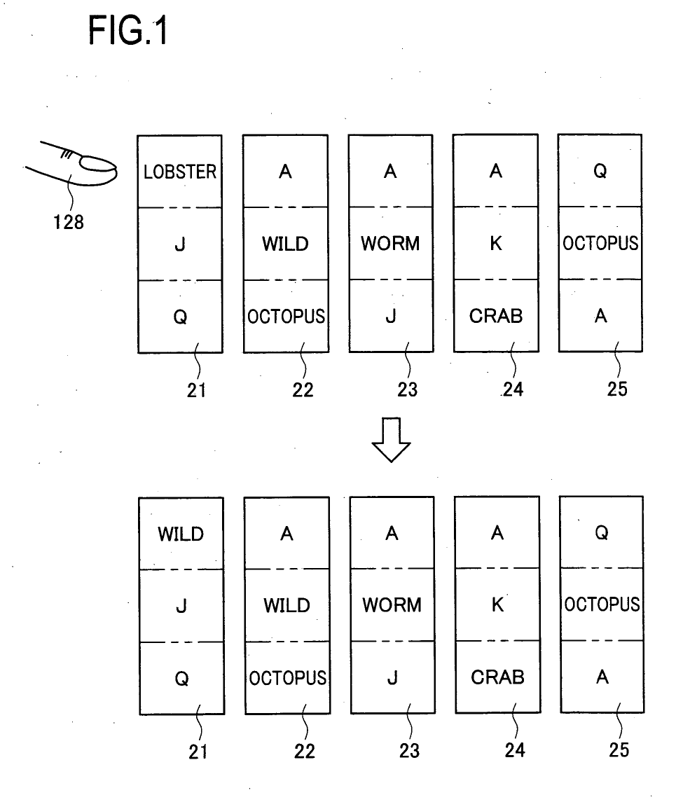

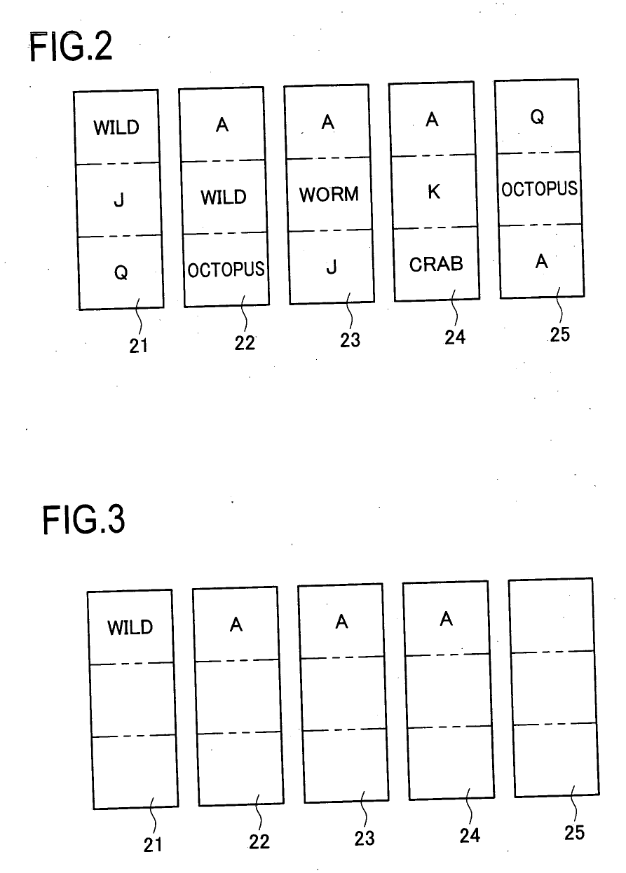

Concretely speaking, for example, in a case that the symbols shown in FIG. 2 are stopped and displayed on each of the variable display portions 21 to 25 in the base game process of FIG. 19 based on the lottery process program of FIG. 18, and if at least more than two of the pay lines are activated, the symbol “WILD” on the activated pay line L2 shown in FIG. 5 is regarded as the symbol “A”, thereby it is realized the winning symbol combination in which four symbols “A” successively appear from the left end of the pay line L2, as shown in FIG. 3. As a result, 25 coins as the payout can be obtained. At that time, as shown in the upper step of FIG. 1, there will be a case that the symbol “LOBSTER” is stopped and displayed in the stop display area 211 of the variable display portion 21 constructing the pay line L2, instead of the symbol WILD”. In this case, when the player touches the stop display area 211 of the variable display portion 21 in which the symbol “LOBSTER” is stopped and displayed by the finger 128, the symbol “LOBSTER” is substituted for the symbol “WILD” and thereafter the symbol “WILD” is displayed. As a result, the symbols shown in FIG. 2 are stopped and displayed on each of the variable display portions 21 to 25, as previously planned. Thereby, 25 coins as the payout can be obtained.

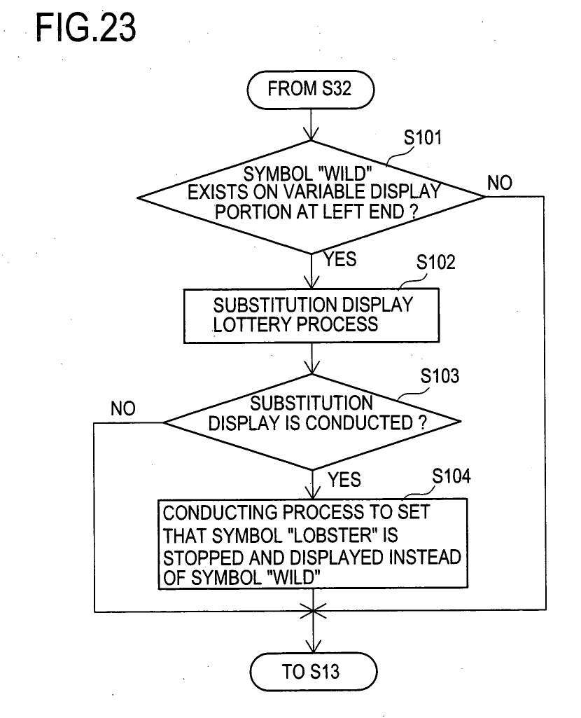

In order to realize the above, for example, a process shown in FIG. 23 is executed at the timing W1 right after the winning symbol combination determination process in S32 in the lottery process program of FIG. 18 is executed. That is to say, in the lottery process program in FIG. 18, after the winning symbol combination determination process in S32 is executed, procedure shifts to S101 in FIG. 23 and it is determined whether or not the symbol “WILD” is to be stopped and displayed in any of the stop display areas 211, 212, 213 of the variable display portion 21, based on a result obtained in the symbol determination process executed in S31 of the lottery process program shown in FIG. 18.

At that time, if it is determined that the symbol “WILD” is not stopped and displayed in any of the stop display areas 211, 212, 213 of the variable display portion 21 (S101: NO), procedure shifts to the base game process in S13 shown in FIG. 16. On the other hand, if it is determined that the symbol “WILD” is stopped and displayed in any of the stop display areas 211, 212, 213 of the variable display portion 21 (S101: YES), procedure shifts to S102.

In S102, a substitution display lottery process is executed. Here, it is conducted a lottery whether or not the substitution display is conducted based on the random number sampled by the random number sampling circuit 56. Thereafter, procedure shifts to S103 and it is determined whether or not the substitution display is executed based on the lottery in S102. If it is determined that the substitution display is not conducted (S103: NO), procedure shifts to the base game process in S13 shown in FIG. 16. On the other hand, if it is determined that the substitution display is conducted (S103: YES), procedure shifts to S104. In S104, it is conducted a process to set that the symbol “LOBSTER” is stopped and displayed instead of the symbol “WILD” which is finally stopped and displayed in any of the stop display areas 211, 212, 213 of the variable display portion 21. Concretely, in the stop control process in S42 in the base game process program shown in FIG. 19, it is transmitted to the liquid crystal drive circuit 74 a signal to execute the substitution display in which the symbol “LOBSTER” is stopped and displayed in any of the stop display areas 211, 212, 213 of the variable display portion 21, instead of the symbol “WILD” which is finally stopped and displayed in any of the stop display areas 211, 212, 213 of the variable display portion 21.

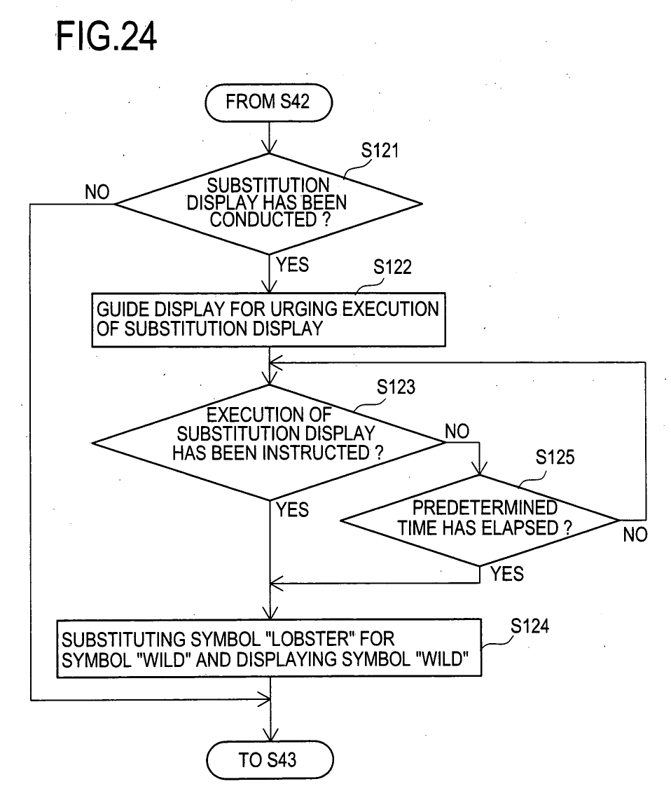

Further, for example, at the timing W2 right after the stop control process in S42 in the base game process program shown in FIG. 19 is executed, a process shown in FIG. 24 is executed. That is to say, in the base game process program shown in FIG. 19, after the stop control process in S42 is conducted, scroll of the symbols on each of the variable display portions 21 to 25 is automatically stopped, as mentioned. At that time, if the signal to execute the substitution display in S104 of FIG. 23 is transmitted, it is conducted the substitution display that the symbol “LOBSTER” is stopped and displayed instead of the symbol “WILD” which is finally stopped and displayed in any of the stop display areas 211, 212, 213 of the variable display portion 21. Thereafter, procedure shifts to S121 of FIG. 24 and it is determined whether or not the substitution display has been conducted. At that time, if it is determined that the substitution display has not been conducted (S121: NO), procedure shifts to the payout process in S43 of FIG. 19. On the other hand, if it is determined that the substitution display has been conducted (S121: YES), procedure shifts to S122.

In S122, a guide display for urging execution of the substitution display is conducted. Concretely, for example, as shown in FIG. 7, it is displayed on the lower liquid crystal display 4 a message M “SUBSTITUTION DISPLAY IS PERMITTED. PLEASE CHANGE THE SYMBOL “LOBSTER” TO THE SYMBOL “WILD” BY TOUCHING THEREON”, by controlling the liquid crystal drive circuit 74.

Thereafter, procedure shifts to S123 and it is determined whether or not the execution of the substitution display has been instructed. Here, it is determined whether or not any of the stop display areas 211, 212, 213, in which the symbol “LOBSTER” is stopped and displayed, of the variable display portion 21 has been touched by the finger 128 based on a signal from the touch panel 121. At that time, if it is determined that the execution of the substitution display has been instructed (S123: YES), procedure shifts to S124. In S124, the symbol “LOBSTER”, which is stopped and displayed in any of the stop display areas 211, 212, 213 of the variable display portion 21, is substituted for the symbol “WILD” and the symbol “WILD” is displayed, thereafter procedure shifts to the payout process in S43 of FIG. 19. On the other hand, if it is determined that the execution of the substitution display has not been instructed (S123: NO), procedure returns to S123 till a predetermined time has elapsed (S125: NO) and it is determined whether or not the execution of the substitution display has been instructed. And if the predetermined time has elapsed (S125: YES) in a state that the execution of the substitution display has not been instructed, procedure shifts to S124. And in S124, the symbol “LOBSTER” stopped and displayed in any of the stop display areas 211, 212, 213 of the variable display portion 21 is substituted for the symbol “WILD” and such symbol “WILD” is displayed.

That is, if the execution of the substitution display has been instructed, the substitution display in S124 is conducted right after the execution of the substitution display has been instructed, and if the execution of the substitution display has not been instructed, the substitution display in S124 is conducted after the predetermined time has elapsed. Thereby, the symbols are displayed on each of the variable display portions 21 to 25, as previously planned (according to the determination determined in the symbol determination process in S31 of FIG. 18), thereafter procedure shifts to the payout process in S43 of FIG. 19 and coins are paid out as previously planned (according to the determination determined in the winning symbol combination determination process in S32 of FIG. 18).

Therefore, in the slot machine 1 of the embodiment, in a case that it is conducted the substitution display in which the symbol “LOBSTER” is stopped and displayed instead of the symbol “WILD” which is finally stopped and displayed in any of the stop display areas 211, 212, 213 of the variable display portion 21 (S104, S42), and the player touches any of the stop display areas 211, 212, 213 of the variable display portion 21 in which the symbol “LOBSTER” is stopped and displayed by the finger 128 (S123: YES), the symbol “LOBSTER” is substituted for the symbol “WILD” and such symbol “WILD” is displayed (S124) and coins are paid out corresponding to the symbol combination displayed on each of the variable display portions 21 to 25 after the substitution display is conducted (S43). Therefore, the player can feel as if the symbol combination with the payout is obtained by the player's own operation, thus a feeling that the player actively conducts the game can be given to the player.

As mentioned in the above, when the process in S124 of FIG. 24 is conducted, the image control CPU 83 functions as “display control device”.

And the CPU 50 functions as “lottery device” when the process in S102 of FIG. 23 is conducted.

The present invention is not limited to the embodiment and various modifications can be made within the scope of the present invention.

For example, in the slot machine 1, only in a case that the symbol “WILD” is to be stopped and displayed in any of the stop display areas 211, 212, 213 of the variable display portion 21 (S101: YES), the substitution display lottery process is conducted (S102) and it is conducted the substitution display in which the symbol “LOBSTER” is stopped and displayed instead of the symbol “WILD” which is finally stopped and displayed in any of the stop display areas 211, 212, 213 of the variable display portion 21, corresponding to the lottery result (S104, S42). Here, although the timing that the lottery is conducted is set to the timing W1 right after it is conducted the winning symbol combination determination process in S32 in the lottery process program shown in FIG. 18, such timing is not limited to the timing W1. For example, such timing may be set to the timing W2 right after it is conducted the stop control process in S42 in the base game process program shown in FIG. 19.

And in a case that the symbol “WILD” is finally stopped and displayed in any of the stop display areas 211, 212, 213 of the variable display portion 21 without conducting the substitution display lottery process in S102 (S101: YES), it may be conducted the substitution display that the symbol “LOBSTER” may be always stopped and displayed instead of the symbol “WILD” which is stopped and displayed in any of the stop display areas 211, 212, 213 of the variable display portion 21.

Further, in the slot machine 1 of the embodiment, although the guide display for urging the execution of the substitution display in S122 of FIG. 24 is realized by the message M displayed on the lower liquid crystal display 4 as shown in FIG. 7, this guide may be conducted by blinking and displaying the symbol “LOBSTER” which is the object of the substitution display.

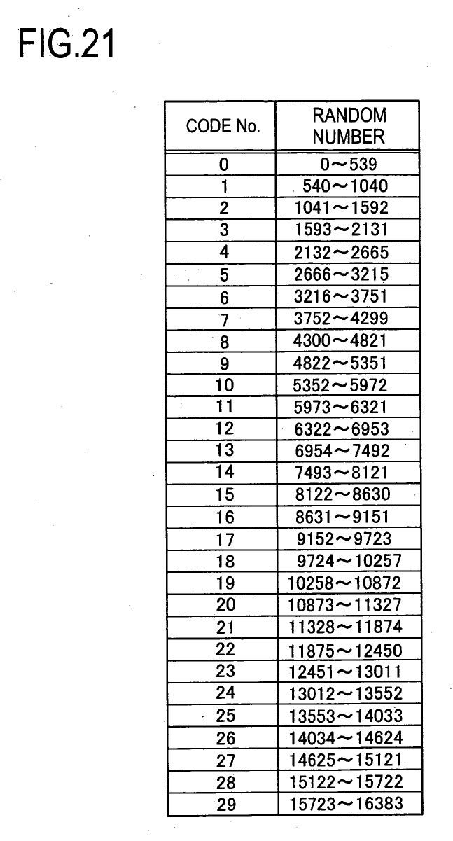

Further, in the slot machine 1 of the embodiment, the symbol stopped and displayed on the pay line constructed from the second stop display areas 212, 222, 232, 242, 252 is determined every each of the variable display portions 21 to 25 in the base game and the bonus game, based on the lottery table in FIG. 14 in which one random number value sampled through the random number sampling circuit 56 and one code No. are corresponded with each other. As for this point, for example, the symbol stopped and displayed on the pay line constructed from the second stop display areas 212, 222, 232, 242, 252 may be determined every each of the variable display portions 21 to 25, based on the lottery table in FIG. 21 in which a specific range of the random numbers sampled through the random number sampling circuit 56 corresponds to one code No.

Further, although the slot machine 1 of the embodiment conducts the video slot game through five reels, it may be conducted the video slot game through three reels or nine reels.

And in the slot machine 1 of the embodiment, it is conducted the substitution display that the symbol “LOBSTER” is stopped and displayed instead of the symbol “WILD” which is finally stopped and displayed in any of the stop display areas 211, 212, 213 of the variable display portion 21. However, the stop display area in which the symbol “LOBSTER” is stopped and displayed is not limited to the stop display areas 211, 212, 213 of the variable display portion 21. For example, it may be conducted the substitution display that the symbol “LOBSTER” is stopped and displayed instead of the symbol “WILD” which is finally stopped and displayed in any of the stop display areas 221 to 253 of the variable display portions 22 to 25 and the symbol “LOBSTER” may be substituted for the symbol “WILD” based on that the player touches any of the stop display areas 221 to 253 of the variable display portions 22 to 25, in which the symbol “LOBSTER” is stopped and displayed, by the finger 128.

And in the slot machine 1 of the embodiment, although the object for the substitution display (S104, S42) and the change display (S124) is set to the symbol “LOBSTER” and the symbol “WILD”, such symbols are not limited to the above combination. For example, such combination may be set to a combination including the symbol “SHARK”, the symbol “FISH”, the symbol “PUNK (person having a guitar), the symbol “OCTOPUS”, the symbol “CRAB”, the symbol “WORM”, the symbol “A”, the symbol “K”, the symbol “Q”, the symbol “J”, the symbol “SARDINE”.

Further, in the slot machine 1 of the embodiment, although the substitution display (S104, S42) and the change display (S124) are conducted against the symbol constructing the winning symbol combination on one activated pay line, such substitution display (S104, S42) and change display (S124) may be conducted at the same time against the independent symbol or the same symbol constructing the winning symbol combination on each of plural activated pay lines. And the number of the activated pay lines may be determined by a lottery.

Further, in the slot machine 1 of the embodiment, although the substitution display (S104, S42) and the change display (S124) are conducted against one symbol, such substitution display (S104, S42) and change display (S124) may be conducted at the same time against plural symbols. And the number of the symbols may be determined by a lottery.

And in the slot machine 1 of the embodiment, although the substitution display (S104, S42) and the change display (S124) are conducted against the symbol constructing the symbol combination corresponding to which the winning symbol combination is realized, such substitution display (S104, S42) and change display (S124) may be conducted against the symbol constructing the symbol combination corresponding to which the winning symbol combination is not realized. Further, such symbol may be determined by a lottery.

The present invention can be applied to a case that the game is executed by using symbols displayed on the display device.

What is claimed is:

1. A gaming machine comprising:
a display device for displaying plural kinds of symbols including a first symbol and a second symbol;
a first determination device for determining a winning symbol combination;
a second determination device for determining whether or not the winning symbol combination determined by the first determination device includes the first symbol;
a contact input device arranged on a display plane of the display device, the contact input device operating in cooperation with the display plane of the display device; and
a display control device for controlling the display device;
wherein the display control device controls the display device to display a symbol combination constructed from the winning symbol combination in which the second symbol is included instead of the first symbol if the second determination device determines that the winning symbol combination includes the first symbol, and
wherein the display control device controls the display device to substitute the second symbol in the symbol combination for the first symbol and display the winning symbol combination including the first symbol when the second symbol is touched through the contact input device.

2. The gaming machine according to claim 1, further comprising:
a game control device for paying out game media corresponding to the winning symbol combination;
wherein the game control device pays out the game media based on the winning symbol combination which is displayed on the display device after the second symbol in the symbol combination is substituted for the first symbol.

3. The gaming machine according to claim 1, further comprising:
an urging device for urging contact to the second symbol through the contact input device after the symbol combination including the second symbol is displayed on the display device.

4. The gaming machine according to claim 3, wherein the urging device controls the display device so as to display a guide message to urge the contact to the second symbol.

5. The gaming machine according to claim 1, further comprising:
a third determination device for determining whether or not a predetermined time elapses since the symbol combination including the second symbol is displayed on the display device;
wherein the display control device controls the display device to automatically substitute the second symbol in the symbol combination for the first symbol and display the winning symbol combination including the first symbol if the third determination device determines that the predetermined time elapses in a state that the second symbol is not touched through the contact input device.

6. The gaming machine according to claim 1, further comprising:
a lottery device for determining by a lottery whether or not the second symbol in the symbol combination is to be substituted for the first symbol.
